(19) United States
(12) Patent Application Publication
(10) Pub. No.: US 2020/0388154 A1
(43) Pub. Date: Dec. 10, 2020

(54) METHOD OF PROVIDING A SERVICE OF A VEHICLE IN AUTOMATED VEHICLE AND HIGHWAY SYSTEMS AND APPARATUS THEREFOR

(71) Applicant: LG Electronics Inc., Seoul (KR)

(72) Inventors: Hyunkyu KIM, Seoul (KR); Kibong SONG, Seoul (KR); Chulhee LEE, Seoul (KR); Sangkyeong JEONG, Seoul (KR); Junyoung JUNG, Seoul (KR)

(21) Appl. No.: 16/490,004

(22) PCT Filed: Jul. 11, 2019
(86) PCT No.: PCT/KR2019/008549

§ 371 Date: Jul. 30, 2020

(51) Int. Cl. G08G 1/0968; G06N 3/08; G06Q 30/06

(52) U.S. Cl. CPC G08G 1/096888; G08G 1/096844; H04W 4/40; G06Q 30/0631; G06N 3/08

(57) ABSTRACT

A method of providing a service of a vehicle in automated vehicle & highway systems is disclosed. The method of providing a service according to an example acquires condition information of a user, road surface condition information of a driving path, traffic information of the driving path, using the sensing unit, predict danger class of the driving path, and select a service provided to the user, based on the condition information of a user, the road surface condition information, the traffic information and danger class. Through this, the invention can provide a most suitable service to the user. One or more of an autonomous vehicle, a user terminal and a server may be connected to an artificial intelligence (AI) module, a drone (unmanned aerial vehicle, UAV) robot, an augmented reality (AR) apparatus, a virtual reality (VR) apparatus, 5G service related apparatus or the like.

### TECHNICAL FIELD

The invention relates to an automated vehicle & highway system, and to a method of providing a service of a vehicle using AI technology and an apparatus for the same.

### BACKGROUND ART

Vehicles may be classified into internal combustion engine vehicles, external combustion engine vehicles, gas turbine vehicles and electric vehicle based on an engine type used therein.

An autonomous vehicle refers to a vehicles capable of driving by itself without operation of a driver or a passenger, and an automated vehicle & highway system refers to a system which monitors and controls so as to allow such autonomous vehicle to drive by itself.

### DISCLOSURE

### Technical Problem

The invention has been made in an effort to address aforementioned necessities and/or problems.

Further, the invention will suggest a method of acquiring road information for autonomous driving by use of AI techniques in the automated vehicle & highway system.

Further, the invention will suggest a method of providing a most suitable service to users through road information acquired by use of AI techniques in the automated vehicle & highway system.

Technical problems, which the invention is to address, are limited to the aforementioned technical problems, and unmentioned or other technical problems may be understood from the following detailed description by a person having an ordinary skill in the art.

### Technical Solution

According to an aspect of the invention, a method of providing a service of a vehicle in automated vehicle & highway systems may include acquiring condition information of a user using the sensing unit, acquiring road surface condition information of a driving path, acquiring traffic information of the driving path, predicting a danger class of the driving path, and determining a service provided to the user, based on the condition information of the user, the road surface condition information, the traffic information and the danger class, wherein the service includes a service for changing driving path, a service for food suggestion, a service for restaurant suggestion, or a service for providing or suggesting contents.

Additionally, the road surface condition information may include location information of the road surface, uniformity information of the road surface, slipperiness information of the road surface, inclination information of the road surface or slope information of the road surface.

Additionally, the method may further include acquiring current location information; acquiring the uniformity information of the road surface corresponding to the current location information; and generating a warning message indicating the road surface is uneven, when the uniformity exceeds an allowable range, based on the uniformity information of the road surface, wherein the allowable range may be set based on the service.

Additionally, the method may further include acquiring sensing data if acquisition of the uniformity information of road surface is failed, and predicting the uniformity information of road surface based on the sensing data.

Additionally, the method may further include acquiring a travel distance range according to the number of wheel rotation, acquiring actual travel distance of the vehicle, and generating a message indicating that the road surface is slippery when the actual travel distance exceeds the travel distance range, based on the number of same wheel rotation.

Additionally, the method may further include acquiring current location information, acquiring inclination information of the road surface corresponding to the current location information, and generating a warning message indicating the road surface is inclined, when inclination degree of the road surface exceeds an allowable range, wherein the inclination information of the road surface may be based on variation in rotation angle value of a wheel during a unit period of time, and the allowed range may be set based on the service.

Additionally, the determining of a service may select the service for changing driving path if the driving path is in an unstable state, wherein the unstable state may be based on the warning message indicating that the road surface is uneven, the warning message indicating that the road surface is inclined, or the danger class.

Additionally, the service for changing driving path may automatically change the driving path, or suggest to the user changing the driving path, based on the traffic information or scheduled arrival time.

Additionally, the determining of a service selects the service for food suggestion, based on the condition information of the driving path, and the road environment information may include the road surface condition information or the road information of the driving path.

Additionally, the method may further include generating a suggested food list, based on the road environment information.

Additionally, the method may further include generating a warning message based on the warning message indicating that the road surface is uneven, the warning message indicating that the road surface is inclined, or the danger class if the condition information of a user indicates a state of food intake.

Additionally, the determining of a service may select the service for restaurant suggestion based on the road surface condition information, the location information of restaurants and the food information sold at the restaurants.

Additionally, the method may further include stopping reproduction of the contents, and displaying the road surface condition information and current sensed image data.

Additionally, the determining of a service may select the service for providing or suggesting contents, based on the warning message indicating that the road surface is uneven or the warning message indicating that the road surface is inclined.

Additionally, the road surface condition information, the traffic information or the danger class may be acquired through V2X (vehicle to everything) communication with other vehicle.

Additionally, the acquiring of the traffic information of the driving path may be based on traffic information acquired through V2X communication from other vehicles or traffic information provided from traffic server.

According to another aspect of the invention, a vehicle which provides a service in automated vehicle & highway systems may include a sensing unit formed with a plurality of sensors, a memory, a processor, wherein the processor may acquire condition information of a user, road surface condition information of a driving path, traffic information of the driving path, using the sensing unit, predict danger class of the driving path through AI processor, select a service provided to the user, based on the condition information of a user, the road surface condition information, the traffic information and danger class, and wherein the service may include a service for changing driving path, a service for food suggestion, a service for restaurant suggestion, or a service for providing or suggesting contents.

### Advantageous Effects

Advantageous effects of a method for providing a service of a vehicle in an automated vehicle & highway system, and of an apparatus for the same, according to an embodiment of the disclosure will now be described as below.

The invention may effectively acquire the road information for autonomous driving by use of AI techniques in the automated vehicle & highway system.

Further, the invention may provide a most suitable service to users through road information acquired by use of AI techniques in the automated vehicle & highway system.

Advantageous effects, which the invention may provide, are limited to the aforementioned ones, and unmentioned or other ones may be understood from the following detailed description by a person having an ordinary skill in the art.

### DESCRIPTION OF DRAWINGS

FIG. 1 exemplifies a block diagram of a wireless communication system to which methods proposed herein may be applied.

FIG. 2 is a drawing illustrating an example of a signal transmitting/receiving method in a wireless communication system.

FIG. 3 shows an example of the basic operation of a 5G network and a user terminal in a 5G communication system.

FIG. 4 is a drawing showing a vehicle according to an example of the disclosure.

FIG. 5 is a block diagram of AI apparatus according to an example of the disclosure.

FIG. 6 is a drawing for illustrating a system to which an autonomous vehicle and an AI apparatus are connected, according to an example of the invention.

FIG. 7 is an example of the DNN model to which the invention may be applied.

FIG. 8 is an example of a determination method of road surface uniformity to which the invention may be applied.

FIG. 9 is an example of a learning method of road surface uniformity prediction to which the invention may be applied.

FIG. 10 is an example of a prediction method of road surface uniformity to which the invention may be applied.

FIG. 11 is an example of a determination method of road surface slipperiness degree to which the invention may be applied.

FIG. 12 is an example of a determination method of inclination degree to which the invention may be applied.

FIG. 13 is an example of a prediction method of inclination degree to which the invention may be applied.

FIG. 14 is an example of a determination method of traffic congestion to which the invention may be applied.

FIG. 15 is an example of a determination method of danger class of the driving path to which the invention may be applied.

FIG. 16 is an example to which the invention may be applied.

FIG. 17 is an example to which the invention may be applied.

Attached drawings, which are included as a part of the detailed description to facilitate understanding of the invention, provide examples of embodiments for the invention, and describe technical features of the invention altogether with the detailed description.

### MODE FOR INVENTION

Hereinafter, exemplary embodiments disclosed herein will be described with reference to attached drawings, in which identical or like components are given like reference numerals regardless of reference symbols, and repeated description thereof will be omitted. Suffixes for components, “module” and “unit” used in the following description, will be given or used in place of each other taking only easiness of specification preparation into consideration, and they do not have distinguishable meanings or roles by themselves. Additionally, it is noted that the detailed description for related prior arts may be omitted herein so as not to obscure essential points of the disclosure. Further, the attached drawings are intended to facilitate the understanding of examples disclosed herein, and the technical spirit disclosed herein is not limited by the attached drawings, and rather should be construed as including all the modifications, equivalents and substitutes within the spirit and technical scope of the invention.

The terms including ordinal number such as, first, second and the like may be used to explain various components, but the components are not limited by the terms. Said terms are used in order only to distinguish one component from another component.

Further, when one element is referred to as being “connected” or “accessed” to another element, it may be directly connected or accessed to the other element or intervening elements may also be present as would be understood by one of skill in the art. On the contrary, when one element is referred to as being “directly connected” or “directly accessed” to another element, it should be understood as that the other element is not present between them.

Singular expression includes plural expression unless explicitly stated to the contrary in the context.

Herein, it should be understood that the terms “comprise,” “have,” “contain,” “include,” and the like are intended to specify the presence of stated features, numbers, steps, actions, components, parts or combinations thereof, but they do not preclude the presence or addition of one or more other features, numbers, steps, actions, components, parts or combinations thereof.

Hereinafter, autonomous driving apparatus requiring AI processed information, and/or 5th generation mobile communication which an AI processor requires will be described through sections A to G.

### A. Example of UE and Network Block Diagram

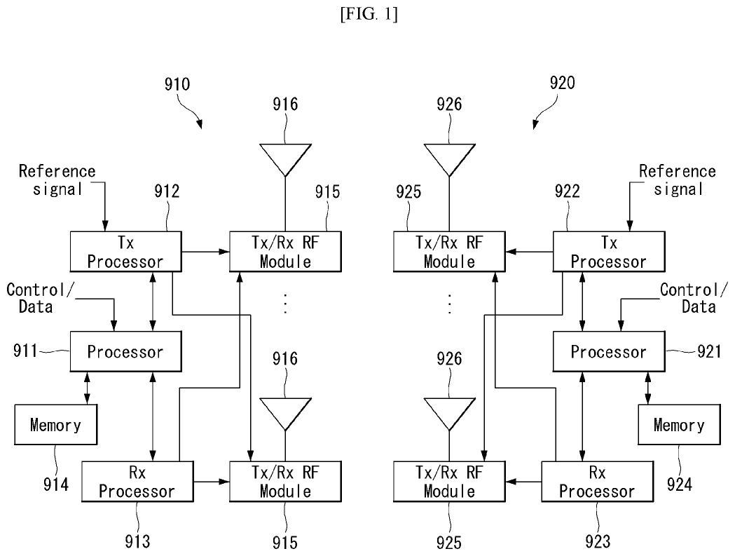

FIG. 1 exemplifies a block diagram of a wireless communication system to which methods proposed herein may be applied.

Referring to FIG. 1, an apparatus (AI apparatus) including an AI module may be defined as a first communication apparatus (910 in FIG. 1), and a processor 911 may perform an AI specific action.

5G network including another apparatus (AI server) communicating with the AI apparatus may be as a second communication apparatus (920 in FIG. 1), and a processor 921 may perform an AI specific action.

The 5G network may be denoted as the first communication apparatus, and the AI apparatus may be denoted as the second communication apparatus.

For example, the first communication apparatus or the second communication apparatus may be a base station, a network node, a transmission terminal, a wireless apparatus, a wireless communication apparatus, a vehicle, a vehicle loaded with a autonomous driving function, a connected car, a drone (unmanned aerial vehicle, UAV), an artificial intelligence (AI) module, a robot, an augmented reality (AR) apparatus, a virtual reality (VR) apparatus, a mix reality apparatus, a hologram apparatus, a public safety apparatus, an MTC apparatus, an IoT apparatus, a medical apparatus, a fintech apparatus (or financial apparatus), a security apparatus, a climate/environmental apparatus, 5G service related apparatus or 4th industrial revolution field related apparatus.

For example, the terminal or user equipment (UE) may include a mobile phone, a smart phone, a laptop computer, a digital broadcasting terminal, a personal digital assistant (PDA), a portable multimedia player (PMP), a navigation, a slate PC, a tablet PC, a wearable devices, e.g., a smartwatch, a smartglass, a head mounted display (HMD), or the like. For example, the HMD may be a display apparatus which is worn an the head. For example, the HMD may be used to embody VR, AR or MR. For example, the drone may be a flying object which is flown by wireless control signals without a human on board. For example, the VR apparatus may include an apparatus for embodying an object or background of a virtual world. For example, the AR apparatus may include an apparatus which embodies by connecting an object or background of a virtual world to an object or background of a real world. For example, the MR apparatus may include an apparatus which embodies by fusing an object or background of a virtual world to an object or background of a real world. For example, the hologram apparatus may include an apparatus which embodies a hologram, i.e., 360 degree three-dimensional image, by recording and replaying three-dimensional information, utilizing Interference phenomenon of light produced when two laser lights meet. For example, the public safety apparatus may include an image relay apparatus or an imaging apparatus which is wearable onto the body of a user. For example, the MTC apparatus and the IoT apparatus may be an apparatus which does not require direct intervention or operation of a human. For example, the MTC apparatus and the IoT apparatus may include smart meters, bending machines, thermometers, smart light bulbs, door locks, various sensors or the like. For example, the medical apparatus may be an apparatus used to diagnose, cure, mitigate, treat, or prevent diseases. For example, the medical apparatus may be an apparatus used to diagnose, cure, mitigate or correct injuries or disabilities. For example, the medical apparatus may be an apparatus used for the purpose of inspecting, replacing, or transforming a structure or function. For example, the medical apparatus may be an apparatus used for the purpose of controlling pregnancy. For example, the medical apparatus may include medical devices, surgical devices, (in vitro) diagnostic devices, hearing aids, medical procedure devices or the like. For example, the security device may be a device installed to prevent danger that may occur and to maintain safety. For example, the security device may be cameras, CCTVs, recorders, black boxes or the like. For example, the fintech apparatus may be devices that can provide financial services such as mobile payments or the like.

Referring to FIG. 1, the first communication apparatus 910 and the second communication apparatus 920 include processors 911,921, memories 914,924, Tx/Rx radio frequency (RF) modules 915,925, Tx processors 912,922, Rx processors 913,923, antennas 916,926. The Tx/Rx module may be referred to as a transceiver. Each of Tx/Rx modules 915 transmits signals toward each of antennas 926. The processor embodies the function, the process and/or the method described above. The processor 921 may be associated with a memory (924) which store program code and data. The memory may be referred to as a computer readable medium. More specifically, in DL (communication from the first communication apparatus to the second communication apparatus), the transmission TX processor 912 embodies various signal processing functions for a L1 layer (i.e., physical layer). The RX processor embodies various signal processing functions of the L1 (i.e., physical layer).

UL (communication from the second communication apparatus to the first communication apparatus) is processed in the first communication apparatus 910 in a similar way as described in connection with the receiving function in the second communication apparatus 920. Each of the Tx/Rx modules 925 receives signals via each of the antennas 926. Each of the Tx/Rx modules provides RF carrier and information to the Rx processor 923. The processor 921 may be associated with a memory (924) which store program code and data. The memory may be referred to as a computer readable medium.

According to an example of the disclosure, the first communication apparatus may be a vehicle, and the second communication apparatus may be a 5G network.

### B. Signal Transmitting/Receiving Method in Wireless Communication System

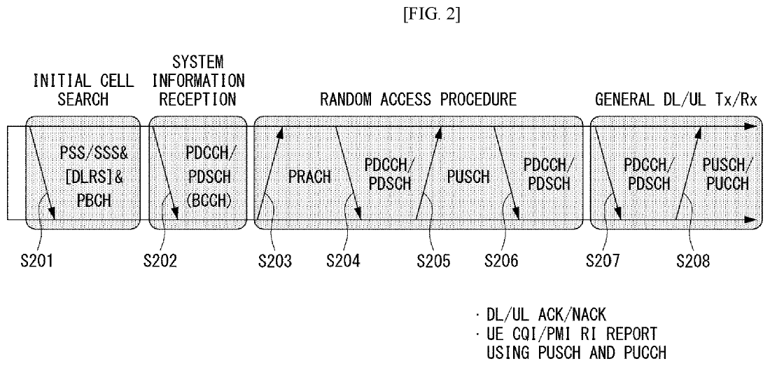

FIG. 2 is a drawing illustrating an example of a signal transmitting/receiving method in a wireless communication system.

Referring to FIG. 2, UE performs initial cell search tasks of synchronizing with BS or the like when turning on power or entering a new cell (S201). For this, UE may receive a primary synchronization channel (P-SCH) and a secondary synchronization channel (S-SCH) to be synchronized with BS and acquire information such as cell ID and the like. In a LTE system and a NR system, the P-SCH and the S-SCH are referred to as a primary synchronization signal (PSS) and a secondary synchronization signal (SSS), respectively. After the initial cell search, UE may receive a physical broadcast channel (PBCH) to acquire broadcast information within a cell. Meanwhile, UE may receive a downlink reference Signal (DL RS) at the initial cell search step to check a downlink channel state. After finishing the initial cell search, UE may acquire more specific system information by receiving a physical downlink control channel (PDCCH) and a physical downlink shared channel (PDSCH) according to information carried by the PDCCH (S202).

Meanwhile, UE may perform a random access procedure (RACH) to BS when there is no wireless resource for initial access or signal transmission to BS (Steps S203 to S206). For this, UE may transmit a certain sequence as a preamble via a physical random access Channel (PRACH) (S203 and S205), and receive a random access response (RAR) message for the preamble via PDCCH and corresponding PDSCH (S204 and S206). In a case of a contention based RACH, a contention resolution procedure may be further performed.

After performing procedures described above, UE may perform PDCCH/PDSCH reception (S207), and physical uplink shared Channel (PUSCH)/physical uplink control channel (PUCCH) transmission (S208) as a general uplink/downlink signal transmission procedure. Particularly, UE receives downlink control information (DCI) via PDCCH. UE monitors a set of PDCCH candidates on monitoring occasions configured in one or more control element sets (CORESET)on a serving cell according to corresponding search space configurations. The set of PDCCH candidates to be monitored by UE may be defined in terms of search space sets, and the search space set may be a common search space set or an UE specific search space set. CORESET is configured with a set of (physic) resource blocks having time duration of 1 to 3 OFDM symbols. The network may be configured, such that UE has a plurality of CORESET. UE monitors PDCCH candidates in one or more search space sets. Here, monitoring means trying to decode PDCCH candidates in the search space. When UE succeeds in decoding one of the PDCCH candidates in the search space , the UE determines that PDCCH has been searched from corresponding PDCCH candidates, and performs PDSCH reception or PUSCH transmission based on DCI in detected PDCCH. PDCCH may be used to schedule DL transmission on PDSCH and UL transmissions on PUSCH. Here, DCI on PDCCH has a downlink assignment (i.e. downlink grant; DL grant), which at least includes the modulation and coding format and the resource allocation information associated with the downlink share channel, or uplink grant (UL grant) that contains the modulation and coding format and the resource allocation information associated with the uplink share channel.

Referring to FIG. 2, the initial access (IA) procedure in the 5G communication system will be further discussed.

UE may perform cell search, system information acquisition, beam alignment for initial access, DL measurement, and the like based on SSB. SSB is used mixed with a Synchronization Signal/Physical Broadcast channel (SS/PBCH) block.

SSB is configured with PSS, SSS and PBCH. SSB is configured in four continuous OFDM symbols, and PSS, PBCH, SSS/PBCH or PBCH is transmitted according to OFDM symbols. PSS and SSS are respectively configured with one OFDM symbol and 127 subcarriers, and PBCH is configured with three OFDM symbol and 576 subcarriers.

Cell search means a procedure in which UE acquires time/frequency of a cell, and detects cell ID (Identifier) (e.g., Physical layer Cell ID (PCI)) of the cell. PSS is used to detects the cell ID in a cell ID group, and SSS is used to detect a cell ID group. PBCH is used to detect SSB (time) index and a half-frame.

There are 336 cell ID groups and 3 cell IDs per cell ID group. There are 1008 cell IDs in total. Information on the cell ID group which the cell ID of the cell belongs to is provided/acquired via SSS of the cell, and information on the cell ID among 336 cells in the cell ID is provided/acquired via PSS.

SSB is periodically transmitted to SSB periodicity. At the initial cell search, SSB basic periodicity assumed by UE is defined as 20 ms. After cell access, SSB periodicity may be configured to be one of {5 ms, 10 ms, 20 ms, 40 ms, 80 ms, 160 ms} by the network (e.g., BS).

Next, the system information (SI) acquisition will be described.

SI is divided into a master information block (MIB) and a plurality of system information blocks (SIBs). SI other than MIB may be referred to as Remaining Minimum System Information (RMSI). MIB includes information/parameter for monitoring of PDCCH which schedules PDSCH carrying SIB1(SystemInformationBlock1), and is transmitted by BS via PBCH of SSB. SIB1 includes information associated with the availability and scheduling (e.g., transmission cycles, SI-Windows sizes) of the remaining SIBs (hereinafter, referred to as SIBx, where x is an integer equal to or greater than 2). SIBx is included in SI message and transmitted via the PDSCH. Each SI message is transmitted within a periodically occurring time window (i.e., SI-Window).

Referring to FIG. 2, a random access (RA) process in the 5G communication system will be further discussed.

The random access process is used for a variety of purposes. For example, the random access process may be used for network initial access, handover and UE-triggered UL data transmission. UE may acquire UL synchronization and UL transmission resources through the random access process. The random access process is divided into a content-based random access process and a contention free random access process. Specific procedure for the contention based random access process is as follows.

UE may transmit the random access preamble as Msg1 of the random access process in UL via PRACH. Random access preamble sequences having two lengths different from each other are supported. The long sequence length 839 is applied to subcarrier spacing of 1.25 and 5 kHz, while the short sequence length 139 is applied to subcarrier spacing of 15, 30, 60 and 120 kHz.

When BS receives the random access preamble from UE, BS transmits the random access response (RAR) message (Msg2) to the UE. PDCCH, which schedules PDSCH carrying RAR, is CRC-masked by a random access (RA) wireless network temporary identifier (RNTI) (RA-RNTI) and transmitted. The UE which detects PDCCH masked by RA-RNTI may receive RARs from PDSCH which is scheduled by the DCI carried by the PDCCH. The UE checks that the random access response information for the preamble which has been transmitted by itself, i.e. Msg1, is within the RAR. Whether there is any random access information for Msg1 which has been transmitted by itself may be determined by whether there is a random access preamble ID for the preambles which has been transmitted by the UE. In the absence of a response to Msg1, the UE may retransmit the RACH preamble within a limited number of times while performing power ramping. The UE calculates the PRACH transmission power for retransmissions of the preamble based on the most recent path loss and power ramp counter.

Based on the random access response information, the UE may transmit UL transmission over the uplink sharing channel as Msg3 of the random access process. Msg3 may include RRC connection requests and UE identifiers. As a response to Msg3, the network may transmit Msg4, which may be treated as a contention resolution message on the DL. By receiving Msg4, the UE may enter into a RRC-connected state.

### C. Beam Management (BM) Procedure of 5G Communication System

A BM process may be divided into (1) a DL BM process using SSB or CSI-RS, and (2) an UL BM process using SRS (sound reference signal). In addition, each BM process may include Tx beam sweeping to determine the Tx beam and Rx beam sweeping to determine the Rx beam.

DL BM process using SSB will now be described.

The setting for beam report using SSB is performed at channel state information (CSI)/beam setting in RRC_CONNECTED.
UE receives from BS, CSI-ResourceConfig IE containing CSI-SSB-ResourceSetList for SSB resources used for BM. The RRC parameter csi-SSB-ResourceSetList represents a list of SSB resources used for beam management and reporting in a set of resources. Here, the SSB resource set may be configured to be {SSBx1, SSBx2, SSBx3, SSBx4, . . . }. An SSB index may be defined as from 0 to 63.
The UE receives signals on SSB resources from the BS based on the CSI-SSB-ResourceSetList.
If CSI-RS reportConfig associated with reporting of SSBRI and reference signal received power (RSRP) is established, the UE reports best SSBRI and RSRP corresponding to it to BS. For example, if the reportQuantity of the CSI-RS reportConfig IE is set to ‘ssb-lndex-RSRP’, the UE reports the best SSBRI and RSRP corresponding to it to BS.

If CSI-RS resources are set to same OFDM symbol(s) as SSB, and ‘QCL-TypeD’ is applicable, the UE may assume that CSI-RS and SSB are quasi co-located (QCL) from a point of view of the ‘QCL-TypeD’. Here, QCL-TypeD may mean being QCL between antenna ports from a point of view of a spatial Rx parameter. The same receive beam may be applied when the UE receives signals from multiple DL antenna ports in the QCL-TypeD relationship.

Next, DL BM process using CSI-RS will now be described.

The Rx beam determination (or refinement) process of the UE using CSI-RS and the Tx beam swiping process of the BS will be are discussed in order. The Rx beam determination process of UE is set for a repetition parameter to be ‘ON’, and the Tx beam swiping process of BS is set for the repetition parameter to be ‘OFF’.

First, the Rx beam determination process of the UE will be described.
The UE receives NZP CSI-RS resource set IE, which includes RRC parameters for ‘repetition’, from the BS through RRC signaling. Here, the RRC parameter ‘repetition’ is set to be ‘ON’.
The UE repeatedly receives from OFDM symbols different from each other via the same Tx beam of the BS (or DL space domain transmission filter), signals on the resource(s) in the CSI-RS resource set in which the RRC parameter ‘repetition’ is set to be ‘ON’.
UE determines its RX beam.
The UE omits the CSI report. That is, if the RRC parameter ‘repetition’ is set to be ‘ON’, the CSI report may be omitted.

Next, the Rx beam determination process of the BS will be described.
The UE receives NZP CSI-RS resource set IE, which includes RRC parameters for ‘repetition’, from the BS through RRC signaling. Here, the RRC parameter ‘repetition’ is set to be ‘OFF’, and associated with the Tx beam sweeping process of BS.
The UE receives via the Tx beams of the BS different from each other (or DL space domain transmission filter), signals on the resources in the CSI-RS resource set in which the RRC parameter ‘repetition’ is set to be ‘OFF’.
The UE selects (or determines) the best beam.
The UE reports the ID (e.g., CRI) and related quality information (e.g., RSRP) for the selected beam to BS. That is, the UE reports the CRI and RSRP for it to BS when CSI-RS is transmitted for BM.

Next, UL BM process using SRS will now be described.
The UE receives from the BS an RRC signaling (e.g., SRS-Config IE) containing the (RRC parameter) usage parameters set to ‘beam management’. The SRS-Config IE is used for SRS transmission configuration. SRS-Config IE includes a list of SRS-Resources and a list of SRS-ResourceSets. Each SRS resource set means a set of SRS-resources.
The UE determines Tx beamforming for SRS resources to be transmitted based on the SRS-SpatialRelation Info included in SRS-Config IE. Here, the SRS-SpatialRelation Info is set for each SRS resources and indicates whether to apply the same beamforming as that used in SSB, CSI-RS, or SRS for each SRS resource.
If SRS-SpatialRelationlnfo is set for an SRS resource, same beamforming as that used in SSB, CSI-RS, or SRS is applied and transmitted . However, if SRS-SpatialRelationlnfo is not set in the SRS resource, the UE arbitrarily determines the Tx beamforming and transmits the SRS through the determined Tx beamforming.

Next, a beam failure recovery (BFR) process will be described.

In a beamformed system, Radio Link Failure (RLF) may occur frequently due to rotation, movement or blockage of the UE. Therefore, BFR is supported in NR to prevent frequent RLFs from occurring. BFR is similar to the radio link failure recovery process, and may be supported if the UE is aware of the new candidate beam(s). To detect beam failure, BS sets beam failure detection reference signals to the UE, which declares beam failure, when the number of beam failure indications from the physical layer of the UE reaches the threshold set by the RRC signaling within the period set by the RRC signaling of the BS. After beam failure has been detected, the UE triggers a beam failure recovery by initiating the random access process on the PCell; select an appropriate beam to perform the beam failure recovery (if the BS provides dedicated random access resources for certain beams, these are preferred by the UE). Upon completion of the random access procedure, the beam failure recovery is considered completed.

### D. URLLC (Ultra-Reliable and Low Latency Communication)

URLLC transmission defined in NR may mean transmission for (1) relatively low traffic size, (2) relatively low arrival rate, (3) extremely low latency requirement (e.g., 0.5 and 1 ms), (4) relatively short transmission duration (e.g., 2 OFDM symbols), (5) urgent service/message, and the like. For UL, transmission for a particular type of traffic (e.g., URLLC) needs to be multiplexed with other pre-scheduled transmission (e.g., eMBB) in order to satisfy more stringent latency requirement. In this regard, one way is to inform the pre-scheduled UE that it will be preempted for a particular resource and to cause URLLC UE to use the corresponding resource in UL transmission.

For NR, dynamic resource sharing between eMBB and URLLC is supported. eMBB and URLLC services may be scheduled on non-overlapping time/frequency resources, and URLLC transmission may occur in resources scheduled for ongoing eMBB traffic. The eMBB UE may not know whether the PDSCH transmission of the corresponding UE was partially punctured, and because of corrupted coded bit, the UE may not be able to decode the PDSCH. Taking this into consideration, NR provides preemption indiction. The above preemption indication may be referred to as the interrupted transmission indication.

With respect to preemption indication, the UE receives the DownlinkPreemption IE through RRC signaling from the BS. When the UE is provided with DownlinkPreemption IE, for monitoring of the PDCCH carrying DCI format 2_1, the UE is set with the INT-RNTI provided by parameter int-RNTI in the DownlinkPreemption IE. The above UE is further set with a set of serving cells by INT-ConfigurationPerServing Cell containing a set of serving cell indexes provided by servingCellID and corresponding sets of locations for fields in DCI format 2_1 by positionInDCI, is set with information payload size for DCI format 2_1 by dci-payloadSize, and is set with indication granularity of time-frequency resources by timeFrequencySect.

The UE receives DCI format 2_1 from the BS on the basis of the DownlinkPreemption IE.

If the UE detects DCI format 2_1 for a serving cell in an established set of serving cells, it may be assumed that among the PRBs and sets of symbols in the last monitoring period before the monitoring period to which the DCI format 2_1 belongs transmits to the DCI format 2_1, none of PRBs and symbols indicated by the DCI format 2_1 transmits to the UE. For example, the UE regards a signal in a time-frequency resource indicated by the preemption as not a scheduled DL transmission to itself, and decodes the data based on the signals received in the remaining resource areas.

### E. mMTC (Massive MTC)

Massive Machine Type Communication (mMTC) is one of 5G's scenarios to support hyper-connected services that communicate simultaneously with a large number of UEs. In this environment, the UE communicates intermittently with extremely low transmission speed and mobility. Therefore, mMTC makes the main goal of how long the UE can be operated at low cost. Regarding mMTC technology, 3GPP deals with MTC and NB (NarrowBand)-IoT.

The mMTC technology features repetitive transmission, frequency hopping, retuning, guard section or the like of PDCCH, PUCCH, PSCH (physical downlink shared channel), PUSCH, and the like.

That is, PUCCH (or PUCCH) containing specific information (or PUCCH (especially long PUCCH) or PRACH) and PDSCH (or PDCCH) containing responses to specific information are repeatedly transmitted. Repetitive transmission is performed via frequency hopping, for repetitive transmission, (RF) retuning is performed in a guard period from the primary frequency resource to the secondary frequency resource, and specific information and response to specific information are transmitted/received via narrowband (e.g., 6 RB (resource block) or 1 RB).

### F. AI Basic Operation Using 5G communication

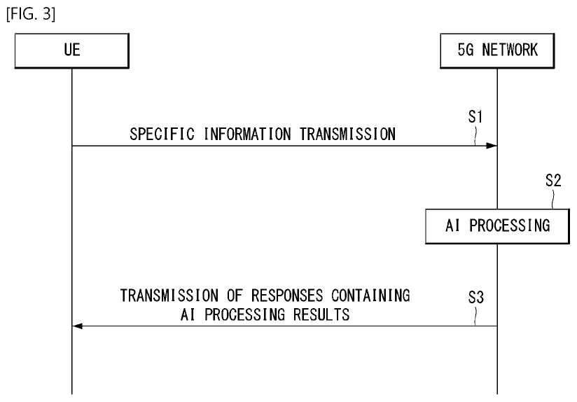

FIG. 3 shows an example of the basic operation of a 5G network and a user terminal in a 5G communication system.

UE transmits specific information transmission to the 5G network (S1). And, the 5G network performs 5G processing for the specific information (S2). Here, the 5G processing may include AI processing. In addition, the 5G network transmits responses containing AI processing results to the UE (S3).

### G. Application Operation Between the User's Terminal and the 5G Network on a 5G Communication System

Hereinafter, AI operation using 5G communication will be more specifically described with reference to FIGS. 1 and 2, and wireless communication techniques (BM procedure, URLLC, Mmtc, and the like) discussed above.

First, the method proposed in this invention to be later described and the basic procedure of application operation applied by eMBB technology of 5G communication will be explained.

In order for the UE to transmit/receive signals, information or the like with 5G network, as in steps S1 and S3 of FIG. 3, the UE performs initial access procedures and random access procedures prior to step S1 of FIG. 3 altogether with 5G network.

More specifically, the UE performs initial access procedures together with 5G network based on the SSB to acquire DL synchronization and system information. In the initial access process, a beam management (BM) process, a beam failure recovery process may be added, and quasi-co location (QCL) relationship may be added in the process of the UE receiving signals from 5G network.

The UE also performs random access procedures together with 5G network for UL synchronization acquisition and/or UL transmission. And, the above 5G network may transmit UL grant to schedule the transmission of specific information to the UE. Therefore, the UE transmits specific information to the 5G network based on the UL grant. And, the 5G network transmits DL grant to schedule the transmission of result of 5G processing on specific information to the UE. Therefore, the 5G network may transmit responses containing AI processing results to the UE based on the above DL grant.

Next, the method proposed in this invention to be later described and the basic procedure of application operation applied by URLLC technology of 5G communication will be explained.

As described above, after the UE performs the initial access procedure and/or the random access procedure altogether with 5G network, the UE may receive the DownlinkPreemption IE from the 5G network. And, the UE receives DCI format 2_1 containing pre-emption indication from the 5G network based on DownlinkPreception IE. In addition, the UE does not perform (or expect or assume) the receipt of eMBB data from resources (PRB and/or OFDM symbols) indicated by the pre-emption indication. Then, the UE may receive UL grant from the 5G network if it needs to transmit certain information.

Next, the method proposed in this invention to be later described and the basic procedure of application operation applied by mMTC technology of 5G communication will be explained.

The part of the steps of FIG. 3, which is changed by the application of the mMTC technology, will be mainly described.

In the step S1 of FIG. 3, the UE receives UL grant from the 5G network in order to transmit certain information to the 5G network. Here, the UL grant may contain information on the number of repetitions for the transmission of specific information, which may be transmitted repeatedly based on information about the number of repetitions. That is, the UE transmits specific information to the 5G network based on the UL grant. And, repeated transmission of specific information may be made through frequency hopping, the first specific information may be transmitted at the first frequency resource, and the second specific information may be transmitted at the second frequency resource. The specific information may be transmitted through narrowband of 6 RB (Resource Block) or 1 RB (Resource Block).

5G communication technology described above may be combined with and applied to methods proposed in this to be described later, or may be provided to embody or clarify the technical features of the methods proposed in this invention.

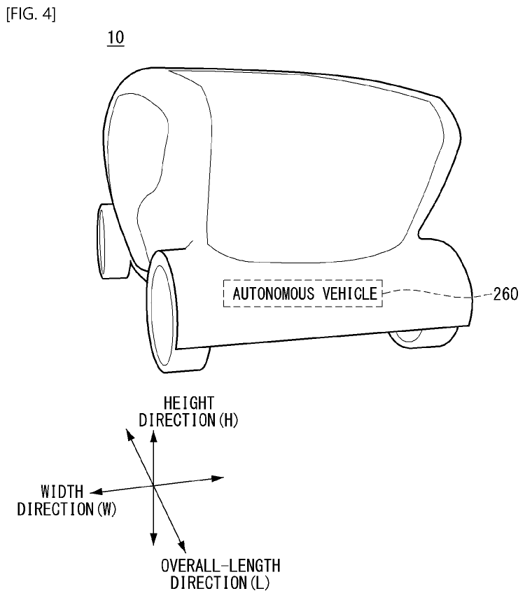

FIG. 4 is a drawing showing a vehicle according to an example of the disclosure.

Referring to FIG. 4, the vehicle 10 according to an example of the disclosure may be defined as a transporting means which drives on a road or a rail. The concept of the vehicle 10 includes an automobile, a train, and a motorbike. A vehicle (10) may be a concept that includes both an internal combustion engine vehicle equipped with an engine as a power source, a hybrid vehicle equipped with an engine and an electric motor as a power source, and an electric vehicle equipped with an electric motor as a power source. The vehicle 10 may be a vehicle owned by an individual. The vehicle 10 may be a shared vehicle. The vehicle 10 may be an autonomous vehicle.

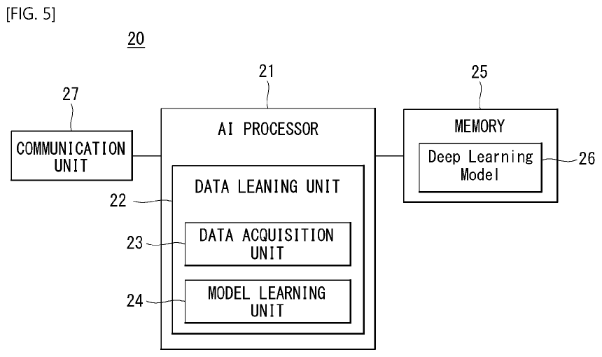

FIG. 5 is a block diagram of AI apparatus according to an example of the disclosure.

The AI apparatus 20 may include electronic devices containing AI modules capable of AI processing, or servers containing the AI modules. In addition, the AI apparatus 20 may be included in at least a partial configuration of the vehicle 10 as illustrated in FIG. 1 and be equipped to perform at least some of the AI processing together.

The AI processing may include all operations related to the driving of the vehicle 10 shown in FIG. 4. For example, autonomous vehicles may perform AI processing of sensing data or driver data to process/decide and generate control signals. Further, for example, autonomous vehicles can perform autonomous driving control by AI processing data acquired through interaction with other electronic devices equipped within the vehicles.

The AI apparatus 20 may include an AI processor 21, a memory 25, and/or a communication unit 27.

The AI apparatus 20 is a computing device that may learn neural networks and may be embodied by various electronic devices such as servers, desktop PCs, notebook PCs, tablet PCs, or the like.

The AI processor 21 may learn neural networks using programs stored in the memory 25. Specifically, the AI processor 21 may learn neural networks for recognizing vehicle-related data. Here, neural networks for recognizing vehicle-related data may be designed to simulate the structure of the human brain on a computer, and include multiple weighted network nodes that simulate the neurons of the human neural network. Multiple network modes may send and receive data according to each connection relationship to simulate the synaptic activity of a neuron sending and receiving signals through a synapse. Here, neural networks may include deep learning models developed from neural network models. In the deep-learning model, multiple network nodes are located in different layers and may send and receive data according to the convolution connection relationship. Examples of neural network models include deep neural networks (DNNs), convolutional deep neural networks (CNNs), Recurrent neural networks (RNNs), Restricted Boltzmann Machine (RBM), deep belief networks (DBNs), Deep Q-Network and the like, and may be applied to fields such as computer vision, voice recognition, natural language processing, voice/signal processing and the like.

Meanwhile, processors that perform the above-described functions may be general processors (e.g., CPU), but they may be AI-only processors (e.g., GPU) for artificial intelligence learning.

The memory 25 may store various programs and data that are needed for operation of the AI apparatus 20. The memory 25 may be embodied by nonvolatile memory, volatile memory, flash-memory, hard disk drive (HDD), solid state drive (SDD) or the like. The memory 25 may be accessed by the AI processor 21, and data may be read/recorded/modified/deleted/renewed by the AI processor 21. Further, the memory 25 may store neural network models (e.g., the deep learning model 26) generated via learning algorithms for data classification/recognition according to an example of this disclosure.

Meanwhile, the AI processor 21 may include a data learning unit 22 that learns the neural network for data classification/recognition. The data learning unit (22) may learn the criteria for which learning data is used to determine data classification/recognition and how data is classified and recognized using learning data. The data learning unit 22 may learn the deep learning model by acquiring the learning data to be used for learning and applying the acquired learning data to the deep learning model.

The data learning unit 22 may be manufactured in the form of at least one hardware chip and may be mounted on AI apparatus 20. For example, the data learning unit, 22 may be manufactured in the form of a dedicated hardware chip for artificial intelligence (AI), or manufactured as a part of a general processor (CPU) or a graphics-only processor (GPU) and be mounted on an AI apparatus 20. Further, the data learning unit 22 may be embodied by a software module. If embodied by a software module (or a program module containing instructions), the software module may be stored in a non-transitory readable recording media which can be read by computer. In this case, at least one software module may be provided by an operating system (OS) or by an application.

The data learning unit 22 may include the learning data acquisition unit 23 and the model learning unit 24.

The learning data acquisition unit 23 may acquire the learning data needed for neural network models to classify and recognize the data. For example, the learning data acquisition unit 23 is learning data, which may be acquired from vehicle data and/or sample data for input into the neural network model.

Using the above acquired learning data, the model learning unit 24 may p learn to allow a neural network model to have criteria for determining how to classify predetermined data. At this time, the model learning unit 24 may make the neural network model learn via a supervised learning which uses at least some of the learning data as a basis for judgment. Alternatively, the model learning unit 24 may learn by itself using learning data without supervision, so that the neural network model is made learn via unsupervised learning which discovers judgment criteria. Further, the model learning unit 24 may make the neural network model learn via reinforcement learning by using feedback on whether the results of learning-based situational judgments are correct. Further, the model learning unit (24) may make a neural network model learn using learning algorithms that include error back-propagation or gradient descent.

Once the neural network model is learned, the model learning unit 24 may store the learned neural network model in a memory. The model learning unit 24 may store the learned neural network model in a memory of servers connected by a wired or wireless network with the AI apparatus 20.

The data learning unit 22 may further include a learning data preprocessing unit (not shown) and a learning data selecting unit (not shown) to improve the analysis results of the recognition model or to save time or resources required to create the recognition model.

The learning data preprocessing unit may preprocess the acquired data so that the acquired data can be used for learning for situation determination. For example, the learning data preprocessing unit may process the acquired data in the previously established format so that the model learning unit 24 can use the acquired learning data for learning for image recognition.

Further, the learning data selecting unit may select data necessary for learning from the learning data acquired in the learning data acquisition unit 23 and the learning data preprocessed in the pre-processing unit. Selected learning data may be provided to the model learning unit 24. For example, the learning data selecting unit may select data only for objects in a specific area by detecting specific areas of the image acquired through the vehicle's camera.

Further, the data learning unit 22 may further include a model evaluation unit (not shown) to improve the analysis results of the neural network model.

The model evaluation unit may make the model learning unit 22 learn again if the evaluation data is input into the neural network model and the analysis result output from the evaluation data does not meet the predetermined standard. In this case, the evaluation data may be data which have been already defined for evaluating the recognition model. For example, the model evaluation unit may evaluate that if the number or percentage of the evaluation data whose analysis result is not correct among the analysis results of the learned recognition model for the evaluation data, exceeds predetermined threshold, it does not meet the predetermined standard.

The communication unit 27 may transmit AI processing results by the AI processor 21 to external electronic devices.

Here, the external electronic device may be defined as an autonomous vehicle. Further, the AI apparatus 20 may be defined as another vehicle or 5G network communicating with said autonomous driving module vehicle. Meanwhile, the AI apparatus 20 may be functionally embedded in an autonomous driving module equipped in the vehicle to be embodied. Further, the 5G network may include servers or modules that perform autonomous driving-related controls.

Meanwhile, the AI apparatus 20 shown in FIG. 5 is described by functionally dividing it into the AI processor 21 and the memory (25), the communication unit (27) and the like, but it should be noted that the aforementioned components may be integrated into a single module and referred to as an AI module.

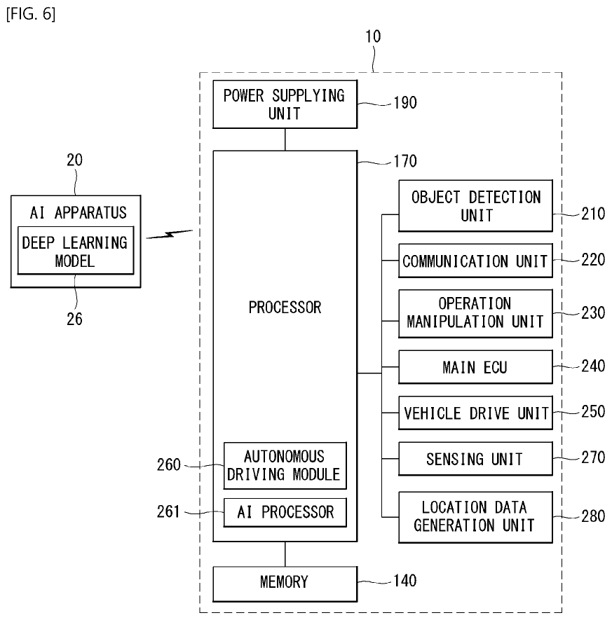

FIG. 6 is a drawing to describe the system in which autonomous driving vehicles and AI devices are connected, according to an example of the disclosure.

Referring to FIG. 6, the autonomous vehicle 10 may transmit data that requires AI processing to the AI apparatus 20 via the communication unit, and the AI apparatus 20 that include the deep learning model 26 may transmit AI processing results generated by using the deep learning model 26 to the autonomous vehicle 10. With regard to the AI apparatus 20, description made in FIG. 2 may be referred to.

The autonomous vehicle 10 may include a memory 140, a processor 170 and a power supplying unit 190, and the processor 170 may be further provided with an autonomous driving module 260 and an AI processor 261. Further, the autonomous vehicle 10 may include an interface that is wired or wirelessly connected to at least one electronic device provided within the vehicle to exchange data necessary for autonomous driving control. At least one electronic device connected through the interface may include an object detection p unit 210, a communication unit 220, an operation manipulation unit 230, a main ECU 240, a vehicle drive unit 250, a sensing unit 270, and a location data generation unit 280.

The interface unit may be configured with at least one of a communication module, a terminal, a pin, a cable, a port, a circuit, an element, and device.

The memory 140 is connected electrically to the processor 170. The memory 140 may store basic data for units, control data for unit operation control and input/output data. The memory 140 may store data which has been processed by the processor 170. The memory 140 may be configured in hardware with at least one of ROM, RAM, EPROM, flash drive or hard drive. The memory 140 may store a variety of data for the entire operation of the autonomous vehicle 10, including programs for processing or control of the processor 170. The memory 140 may be embodied to be integral with the processor 170. According to an example, the memory 140 may be classified into a sub-configuration of the processor 170.

The power supplying unit 190 may supply power to the autonomous driving apparatus 10. The power supplying unit 190 may supply power to each unit of the autonomous vehicle 10 by receiving power from the power source (e.g. battery) contained in the autonomous vehicle 10. The power supplying unit 190 may be operated according to the control signal provided by the main ECU 240. The power supplying unit 190 may include a switched-mode power supply (SMPS).

The processor 170 may be electrically connected to the memory 140, the interface 280, and the power supplying unit 190 to exchange signals. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other function.

The processor 170 may be driven by power supplied from the power supplying unit 190. The processor 170 may receive data, process data, and generate signals, and provide signals, in a state where power is supplied by the power supplying unit 190.

The processor 170 may receive information from other electronic apparatus within the autonomous vehicle 10 via the interface. The processor 170 may provide control signals to other electronic apparatus within the autonomous vehicle 10 via the interface.

The autonomous vehicle 10 may include at least one printed circuit board (PCB). The memory 140, the interface, the power supplying unit 190 and the processor 170 may be electrically connected to the printed circuit board.

Hereinafter, other electronic apparatus within the vehicle connected to the interface, the AI processor 261 and the autonomous driving module 260 will be described more in detail. Hereinafter, for the convenience of explanation, the autonomous vehicle 10 will be referred to as vehicle 10.

First, the object detection unit 210 may generate information about objects outside the vehicle 10. By applying a neural network model to data acquired through object detection unit 210, the AI processor 261 may generate at least one of the existence of an object, location information of the object, distance information of the vehicle and the object, and relative speed information of the vehicle and the object.

An object detection unit 210 may include at least one sensor capable of detecting objects outside the vehicle 10. The sensor may include at least one of cameras, radars, LiDARs, ultrasonic sensors and infrared sensors. The object detection unit 210 may provide data for the object created based on sensing signals generated by the sensor to at least one electronic device included in the vehicle.

Meanwhile, the vehicle 10 transmits data acquired from at least one sensor to the AI apparatus 20 via the communication unit 220, and the AI apparatus 20 may transmit to the vehicle 10 AI processing data generated by applying a neural network model 26 to the delivered data. The vehicle 10 recognizes information for the detected objects based on the AI processing data received, and the autonomous driving module 260 may perform autonomous driving control operation using the information recognized.

The communication unit 220 may exchange signals with a device located outside the vehicle 10. The communication unit 220 may exchange signals with at least one of an infrastructure (e.g., server, broadcasting station), other vehicle, and a terminal. The communication unit 220 may include at least one of transmitting antennas, receiving antennas, Radio Frequency (RF) circuits and RF devices that can embody various communication protocols, in order to perform communication.

By applying a neural network model to data acquired through object detection unit 210, at least one of the existence of an object, location information of the object, distance information of the vehicle and the object, and relative speed information of the vehicle and the object may be generated.

The operation manipulation unit 230 is a device that receives user input for operation. In a manual mode, the vehicle 10 may be driven based on signals provided by the operation manipulation unit 230. The operation manipulation unit 230 may include a steering input apparatus (e.g., steering wheel), an acceleration input apparatus (e.g., accelerator pedal), and brake input devices (e.g., brake pedal).

Meanwhile, in an autonomous driving mode, the AI processor 261 may generate input signals of the operation manipulation unit 230 according to the signals for controlling vehicle movement based on a driving plan generated via the autonomous driving module 260.

Meanwhile, the vehicle 10 transmits data necessary for controlling of the operator manipulation unit 230 to the AI apparatus 20 via the communication unit 220, and the AI apparatus 20 may transmit to the vehicle 10 AI processing data generated by applying a neural network model 26 to the delivered data. The vehicle 10 may use for movement control of the vehicle the input signals of the operator manipulation unit 230 based on the AI processing data received.

The main ECU 240 may control general operation of the at least one electronic apparatus provided within the vehicle 10.

The vehicle drive unit 250 is an apparatus which electrically control various vehicle driving apparatuses within the vehicle 10. The vehicle drive unit 250 may include a powertrain drive control apparatus, a chassis drive control apparatus, a door/window drive control apparatus, a safety apparatus drive control apparatus, a lamp drive control apparatus and an air conditioning drive control apparatus. The powertrain drive control apparatus may include a driving force source control apparatus and a transmission drive control apparatus. The chassis drive control apparatus may include a steering wheel drive control apparatus, a brake drive control apparatus and a suspension drive control apparatus. On the other hand, the safety apparatus drive control apparatus may include a safety belt drive control apparatus for seat belt control.

The vehicle drive unit 250 includes at least one electronic control unit (e.g., the Electronic Control Unit (ECU)).

The vehicle drive unit 250 may control a powertrain, a steering apparatus and a brake apparatus based on signals received from the autonomous driving module 260. The signal received from the autonomous driving module 260 may be a drive control signal generated from the AI processor 261 by applying a neural network model to vehicle related data. The drive control signal may be signals received from an external AI apparatus 20 via the communication unit 220.

The sensing unit 270 may sense conditions of the vehicle. The sensing unit 270 may include at least any one of a Inertial Measurement Unit (IMU) sensor, a crash sensor, a wheel sensor, a speed sensor, a slope sensor, a weight sensor, a heading sensor, a position module, a vehicle forward/rearward sensor, a battery sensor, a fuel sensor, a tire sensor, a steering sensor, a temperature sensor, a humidity sensor, an ultrasonic sensor, an illumination sensor, a pedal position sensor. Meanwhile, the initial measurement unit (IMU) sensor may include one or more of an acceleration sensor, a gyro sensor and a magnetic sensor.

By applying a neural network model to sensing data generated by at least one sensor, the AI processor 261 may generate condition data of the vehicle. The AI processing data generated by the neural network model may include vehicle attitude data, vehicle motion data, vehicle yaw data, vehicle roll data, vehicle pitch data, vehicle impact data, vehicle direction data, vehicle angle data, vehicle speed data, vehicle acceleration data, vehicle acceleration data, vehicle inclination data, vehicle forward/rearward data, vehicle weight data, battery data, fuel data, tire pressure data, vehicle internal temperature data, humidity data in the vehicle, steering wheel rotation angle data, external illumination data, data for pressure on the accelerator pedal, data for pressure on the brake pedal, and the like.

The autonomous driving module 260 may generate a driving control signal based on the AI processed vehicle condition data.

Meanwhile, the vehicle 10 transmits sensing data acquired from at least one sensor to the AI apparatus 20 via the communication unit 22, and the AI apparatus 20 may transmit to the vehicle 10 AI processing data generated by applying a neural network model 26 to the delivered sensing data.

The location data generation unit 280 may generate location data of the vehicle 10. The location data generation unit 280 may include at least any one of a Global Positioning System (GPS) and Differential Global Positioning System (DGPS).

By applying a neural network model to location data generated by at least one location data generation apparatus, the AI processor 261 may generate more accurate location data of the vehicle.

According to an example, the AI processor 261 may perform deep-learning calculation based on at least one of the camera images of the Inertial Measurement Unit (IMU) of the sensing unit 270 and the object detection apparatus 210, and calibrate location data based on generated AI processing data.

Meanwhile, the vehicle 10 transmits the location data acquired from the location data generation unit 280 to the AI apparatus 20 via the communication unit 220, and the AI apparatus 20 may transmit to the vehicle 10 AI processing data generated by applying a neural network model 26 to the location data received.

The vehicle 10 may include an internal communication system 50. A plurality of electronic devices provided in the vehicle 10 may exchange signals via the internal communication system 50. Data may be included in the signal. The internal communication system 50 may use at least one communication protocol (e.g., CAN, LIN, FlexRay, MOST, Ethernet).

Based on the data acquired, the autonomous driving module 260 may generate a path for autonomous driving and create a driving plan for driving along the generated path.

The autonomous driving module 260 may embody at least one Advanced Driver Assistance System (ADAS) function. The ADAS may embody at least any one of a Adaptive Cruise Control (ACC) system, an Automatic Emergency Braking (AEB) system, a Forward Collision Warning (FCW) system, a Lane Keeping Assist (LKA) system, a Lane Changing Assist (LCA) system, a Target Following Assist (TFA) system, a Blind Spot Detection (BSD) system, an Adaptive High Beam Control (HBA: high beam assist) system, an Auto Parking System (APS), a Pedestrian Collision Warning System, a Traffic Sign Recognition (TSR) System, a Traffic Sign Assist (TSA) system, a Night Vision System (NV), Driver Status Monitoring (DSM) system and a Traffic Jam Assist (TJA) system.

The AI processor 261 may transmit control signals capable of performing at least one of the ADAS functions to the autonomous driving module 260 by applying to the neural network model at least one sensor equipped with the vehicle, traffic-related information received from an external device, and information received from other vehicles communicating with the vehicle above.

Further, the vehicle 10 may transmit to the AI apparatus 20 at least one data to perform ADAS functions via the communication unit 220, and the AI apparatus 20 may apply the neural network model 260 to the data received, thereby transmitting to the vehicle 10 control signals that can perform the ADAS function.

The autonomous drive module 260 acquires driver status information and/or vehicle condition information via the AI processor 261, and based on this, switching from an autonomous driving mode to a manual driving mode or switching from a manual driving mode to an autonomous driving mode may be performed.

Meanwhile, the vehicles 10 may use in driving control AI processing data for supporting passengers. For example, as described above, at least one sensor provided in the vehicle may be used to check the conditions of the driver and passenger.

Alternatively, the vehicle 10 may recognize the voice signals of the driver or passenger, perform a voice processing operation and perform a voice synthesis operation, through the AI processor 261.

In the above, the 5G communication required to embody the vehicle control method in accordance with an example of the disclosure, and schematic description for performing the AI processing by applying the 5G communication and transmitting and receiving AI processing results have been discussed.

5G communication technology described above may be combined with and applied to methods proposed in this to be described later, or may be provided to embody or clarify the technical features of the methods proposed in this invention.

Hereinafter, various embodiments of the invention will be described with reference to accompanying drawings.

### Deep Neural Network (DNN) Model

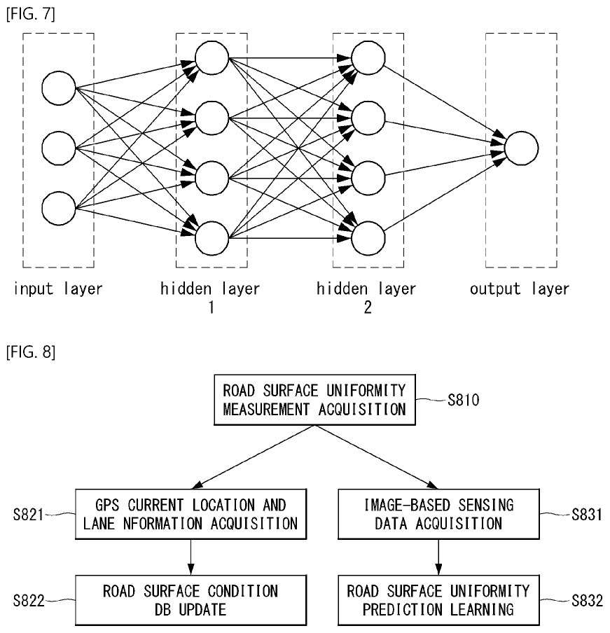

FIG. 7 is an example of the DNN model to which the invention may be applied.

The Deep Neural Network (DNN) is an artificial Neural Network (ANN) formed with several hidden layers between an input layer and an output layer. The Deep Neural Networks may model complex non-linear relationships, as in a typical artificial neural networks.

For example, in the deep neural network structure for an object identification model, each object may be represented by a hierarchical configuration of the image basic elements. At this time, the additional layers may aggregate the characteristics of the gradually gathered lower layers. This feature of deep neural networks allows more complex data to be modeled with fewer units (nodes) than similarly performed artificial neural networks.

As the number of hidden layers increases, the artificial neural network is called “deep,” and machine learning paradigm that uses such a sufficiently deepened artificial neural network as a learning model is called deep learning. And, the sufficiently deep artificial neural network used for such deep learning is commonly referred to as the Deep Neural network (DNN).

In this disclosure, the sensing data of vehicle 10 or the data required for autonomous driving may be input into the input layer of DNN , and as they go through the hidden layers, meaningful data that can be used for autonomous driving can be generated through the output layer.

The specification of the disclosure commonly refers to the artificial neural network used for this deep learning method as the DNN, but other methods of deep learning may be applied as long as meaningful data can be output in a similar way.

Conventionally, the autonomous vehicle only provides equipment for passengers in the autonomous driving state, but fails to provide a control method for avoiding disrupting the behavior of passengers. Further, methods for perceiving the tendency and condition of the occupants and providing services according to the corresponding perception in the autonomous driving state were also rare.

Therefore, in the disclosure, the sensing data of the vehicle (10) and the data required for driving are learned through DNN, then AI technology is utilized to predict the autonomous driving path and environment in advance so that occupants can receive optimal service according to these predicted results. To this end, the vehicle 10 may acquire the user's current condition information through the interior sensors, and with this condition information as input, the AI processor 261 may predict the user's current condition.

Hereinafter, the disclosure will propose following services and control methods.
Method for defining condition of road surface
Method for perceiving whether the driving path is curved
Method for perceiving a slope road in the driving path
Method for determining the traffic congestion
Method for determining danger class of the driving path
Driving path change service
Food/Restaurant suggestion service
Contents proposal (suggestion)/limitation service

For example, users of autonomous driving may consume drinks or food without caring about the driving environment. The vehicle 10 may recognize the user's condition information and control the driving environment depending on the users condition. If the food the user is consuming is difficult to consume in unstable driving conditions, the vehicle may modify the conventional driving path and guide the user to a new, stable driving path.

FIG. 8 is an example of a determination method of road surface uniformity to which the invention may be applied.

As described above, the stability of the driving conditions of the vehicle 10 may be affected by the road conditions, and information on the road surface conditions must be acquired for the vehicle (10) to present a stable driving path. To do this, the vehicle 10 needs to be able to analyze road surface condition through the AI processor 261, and to learn about road surface condition through the deep learning model in the AI apparatus 20. The road surface condition information includes location information, uniformity, slipperiness information, tilt information, and slope information of the road surface to be described.

S810: The vehicle 10 measures the uniformity of the road surface via a sensor. Sensors for this may include gyroscope sensors, motion sensors and the like. Measured uniformity measurements may have values, for example, from 0 to 9. The smaller the measured value, the more uniform the measured road surface is, and the larger the measured value, the more uneven the measured road surface is.

S821: Measurement of the uniformity of the road surface should include location information together for storage in the road surface DB (Data Base). For this, the vehicle 10 may acquire location information for the measured road surface using GPS. This location information includes road information and lane information on the corresponding road surface.

S822: Measurements of road surface uniformity with location information are stored in the road surface condition DB. The road surface condition DB may be stored in the memory 140 of the vehicle 10, or be managed through a separate server or a cloud.

S831: In addition, the vehicle 10 may acquire sensing data for road surfaces measured via image sensors (e.g., Radar/Lidar/Camera sensors) or the like.

S832: These acquired sensing data may be combined with the road surface uniformity measurement, and may be learned through AI technology to predict surface uniformity only with image-based sensing data in the AI apparatus 20 or the AI processor 261.

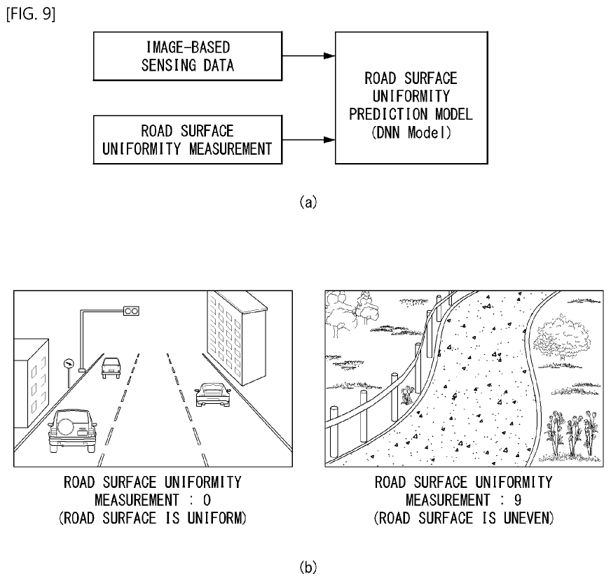

FIG. 9 is an example of a learning method of road surface uniformity prediction to which the invention may be applied.

Referring to FIG. 9A, the road surface uniformity prediction model may be learned to predict the uniformity of the road surface through image-based sensing data and measurements of the uniformity of the actual measured road surface. This road surface uniformity prediction model may be included in the AI apparatus 20 or the AI processor 261.

In the road surface uniformity prediction model, the DNN model described above may be used. Through the input layer of the DNN model, image-based sensing data and road surface uniformity measurements of the corresponding road surface may be input, and these input values pass through the hidden layer, and may be learned to yield the output value from which the degree of uniformity of the road surface can be predicted by the image-based sensing data alone.

Referring to FIG. 9B, for example, the road surface uniformity prediction model may learn that when an image-based sensing data is input for a road with a surface uniformity measurement value of 0, “The road surface on which images showing this shape are sensed is a uniform road surface” . To the contrary, the road surface uniformity prediction model may learn that when an image-based sensing data is input for a road with a surface uniformity measurement value of 9, “The road surface on which images showing this shape are sensed is an uneven road surface”.

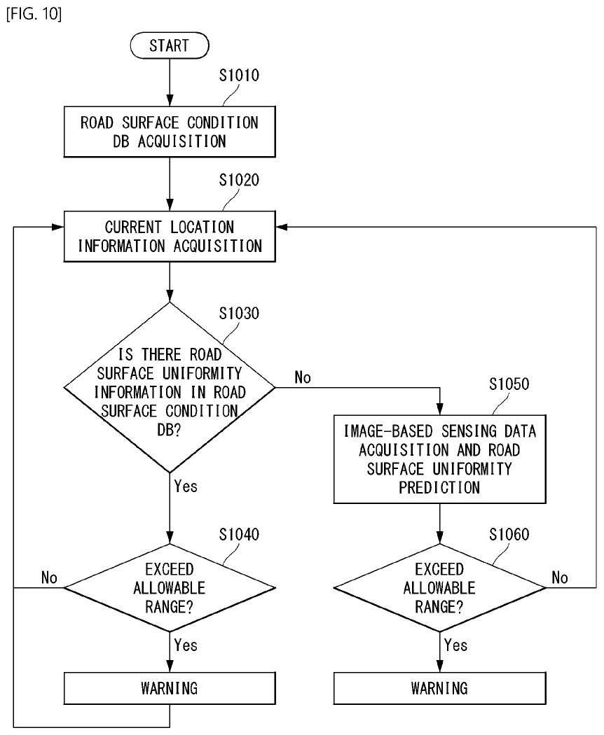

FIG. 10 is an example of a prediction method of road surface uniformity to which the invention may be applied.

S1010: The vehicle 10 acquires a road surface condition DB stored in the server or memory 140. The road surface condition DB may manage the road surface condition information.

S1020: A moving vehicle may acquire its current location information in real time using GPS.

S1030: The vehicle 10 determines based on the acquired location information whether there is information on the road surface uniformity of the road on which it is driving or is scheduled to drive in the road surface condition DB.

S1040: If there is road surface uniformity information within the road surface condition DB, which the vehicle 10 requires for driving, the vehicle 10 will acquire it to determine whether it is within the allowable range.

Here, the allowable range is a range of road surface uniformity measurements required by the services provided by the vehicle 10 to the user based on the user's condition information, and it may be set differently depending on the user's condition information or the type of service that is being provided or to be provided. Depending on whether the allowable range is exceeded, the vehicle 10 may generate a warning message, notify it to the user, or trigger a change in driving condition on this basis.

S1050: If no road surface uniformity information is present in the road surface condition DB, the vehicle 10 may acquire the sensing data through the image-based sensors and predict the road surface uniformity of the road surface on which it drives or will drive, through the road surface uniformity prediction model.

S1060: by determining whether the predicted road surface uniformity measurements are within the aforementioned allowable range, a warning message may be generated through it.

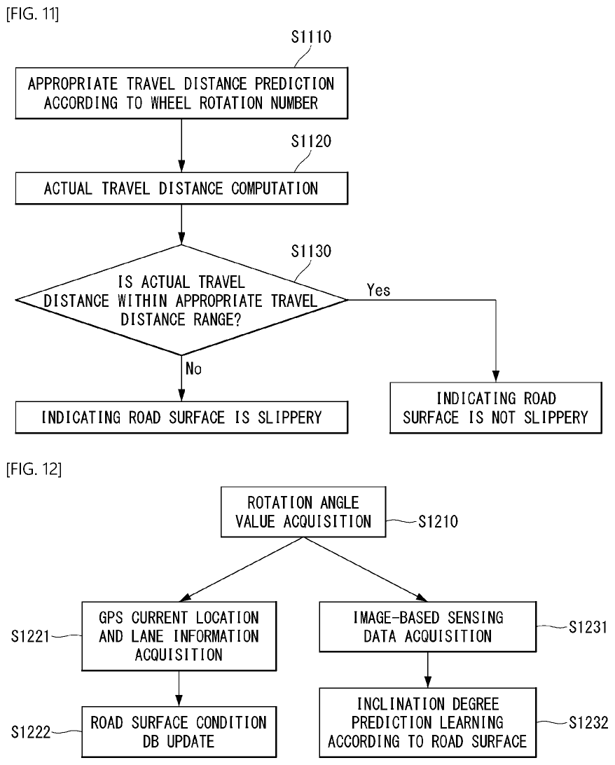

FIG. 11 is an example of a determination method of road surface slipperiness degree to which the invention may be applied.

S1110: The vehicle 10 may predict the appropriate travel distance according to the number of wheel rotations in the vehicle, through the AI processor 261.

An appropriate travel distance may be set in advance according to types of vehicles, or it may be predicted by deep learning within the AI processor with the wheel rotation value during vehicle 10 driving and, in response, the travel distance measured through GPS as input values. The appropriate travel distance is the range of travel distance which the vehicle can be expected to travel according to the number of wheel rotation on a normal road based on a dry and general asphalt road.

S1120: The vehicle 10 measures the actual travel distance by means of GPS information while driving, which can be classified according to the number of wheel rotations.

S1130: The processor 170 determines whether the actual travel distance is within the range of the appropriate travel distance based on the same number of wheel rotations.

If within the range of appropriate travel distance, the processor 170 may generate a message that indicates that the road surface is not slippery, and if it is outside the appropriate distance range, it can generate a message that indicates that the road surface is slippery.

FIG. 12 is an example of a determination method of inclination degree to which the invention may be applied.

Here, the inclination degree means the degree of inclination of the vehicle 10 that may affect the user if the vehicle 10 is driving, changing lanes or entering a curve portion.

The vehicle 10 determines the degree of inclination through the sensing of the steering system.

The steering system converts the rotation of the steering wheel to the rotation of the vehicle's wheels. Further, the steering system allows the user to rotate the wheel with minimal effort in the desired direction. These steering systems are designed to allow the user to control, continuously adjust the steering path of the vehicle and include components for this.

S1210: The processor 170 acquires wheel rotation angle values through a sensor or the like attached to the steering system.

S1221: In order to be stored in the road surface condition DB, these rotation angle values must include the location information together. For this, the vehicle 10 may acquire location information for the measured road surface using GPS. This location information includes road information and lane information on the corresponding road surface.

S1222: The rotation angle value with the location information is stored in the road surface condition DB. The road surface condition DB may be stored in the memory 140 of the vehicle 10, or be managed through a separate server or a cloud.

S1231: In addition, the vehicle 10 may acquire sensing data for road surfaces measured via image sensors (e.g., Radar/Lidar/Camera sensors) or the like.

S1232: This acquired sensing data may be combined with the rotation angle value, and may be learned through AI technology to predict the degree of inclination only with image-based sensing data in the AI apparatus. Such inclination degree value may have, for example, from 0 to 9, and the greater the variation in the rotation angle value over a unit period of time, the greater the degree of inclination felt by the user of the vehicle 10, so it may be computed using the variation in the rotation angle value during a unit period of time.

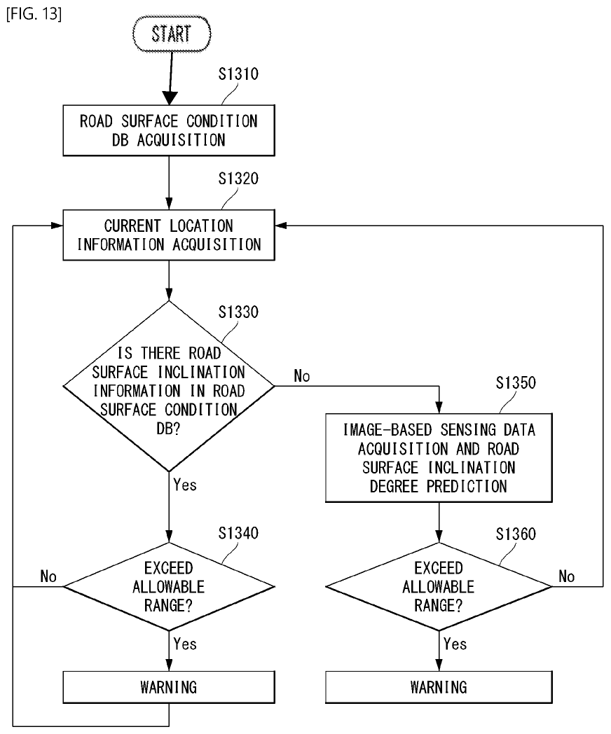

FIG. 13 is an example of a prediction method of inclination degree to which the invention may be applied.

S1310: The vehicle 10 acquires a road surface condition DB stored in the server or memory 140.

S1320: A moving vehicle may acquire its current location information in real time using GPS.

S1330: The vehicle 10 determines based on the acquired location information whether there is information on the road surface inclination of the road on which it is driving or is scheduled to drive in the road surface condition DB.

S1340: If there is road surface inclination information within the road surface condition DB, which the vehicle 10 requires for driving, the vehicle 10 will acquire it to determine if it is within the allowable range.

Depending on whether the allowable range is exceeded, the vehicle 10 may generate a warning message, notify it to the user, or trigger a change in driving condition on this basis.

S1350: If no road surface inclination information is present in the road surface condition DB, the vehicle 10 may acquire the sensing data through the image-based sensors and predict the road surface inclination of the road surface on which it drives or will drive, through the road surface inclination prediction model.

the surface inclination prediction model, similar to the above road uniformity prediction model, may perform deep learning with image-based sensing data and wheel rotation angle values as input values.

S1360: The processor 170 may determine whether the predicted road surface inclination degree is within the aforementioned allowable range, and may generate a warning message through it.

The vehicle 10 of the disclosure may use AI technology to predict the inclination degree of the driving path. For this, the AI processor 261 may predict the inclination degree of the road in the direction of driving, using image-based sensing data as input values. For example, with a height value for the horizon that can be acquired through a front camera sensor, as an input value, if the height is higher than the reference of the flatland driving, it can be predicted that the road ahead in the driving direction has an uphill inclination. Conversely, if the height is lower than the reference of the flatland driving, it can be predicted that the road ahead in the driving direction has a downhill inclination. The elevation degree of height of the horizon acquired from the sensing data may be indicated in a numerical value, so that inclination degree value can be estimated. In addition, the engine load value of the vehicle 10 may be considered as an input to further increase the accuracy of the inclination degree estimation. That is, the AI processor 261 may predict the inclination degree of the driving path, depending on the degree of engine load.

Further, inclination degree values for the driving path may be acquired through road information that may be acquired using the server, the cloud.

Thus acquired inclination degree value may be used for the services to be provided to the user to be described later.

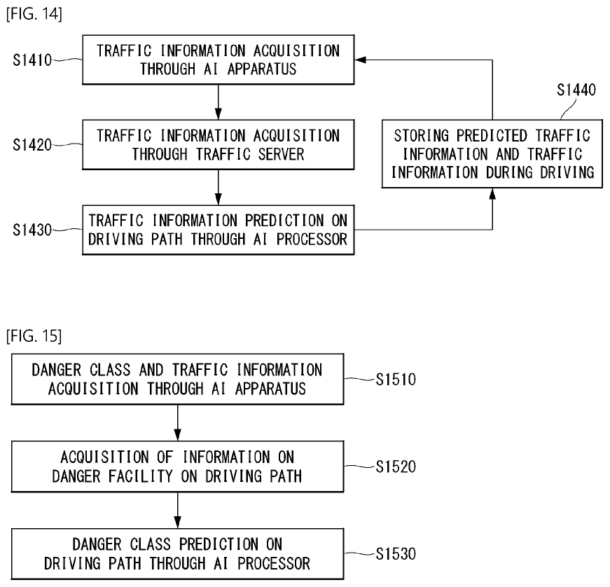

FIG. 14 is an example of a determination method of traffic congestion to which the invention may be applied.

S1410: The vehicle 10 acquires traffic information of the driving path provided by the AI apparatus 20. Such traffic information of the driving path may be provided through deep learning with traffic information acquired through V2X communication from autonomous driving vehicles, and past traffic information provided by a traffic server as input values.

S1420: The vehicle 10 may further acquire real time traffic information of the driving path provided by the traffic server.

S1430: The AI processor 261 may predict traffic information of the driving path by using traffic information provided by the AI apparatus 20 and real time traffic information provided by the traffic server as input values.

S1440: The predicted traffic information and traffic information acquired through actual driving may be reused as inputs to increase the accuracy of the predicted traffic information on the AI apparatus 20.

FIG. 15 is an example of a determination method of danger class of the driving path to which the invention may be applied.

S1510: The vehicle 10 acquires danger class and traffic information of the driving path through the AI apparatus 20. Here, the danger class means degree of attention during driving on the driving path, which has been previously learned through the AI apparatus 20 or the AI processor 261. That is, the higher the danger class is, the more control methods and services for a safe driving may be required for the users of the vehicle 10 who drives on the corresponding driving path. This danger class may be also generated, similar to the traffic information described above, through the deep learning with the sensing information received from autonomous vehicles and the traffic information provided by the traffic server as input values.

S1520: The vehicle 10 acquires information on danger facilities existing in the driving path. It may be acquired through V2X communication from other autonomous vehicles, or may be acquired in real time through sensing information generated by traffic servers or the corresponding vehicle 10.

S1530: The AI processor 261 of the vehicle may predict the danger class of the driving path with the information acquired in the first and second stages as input values.

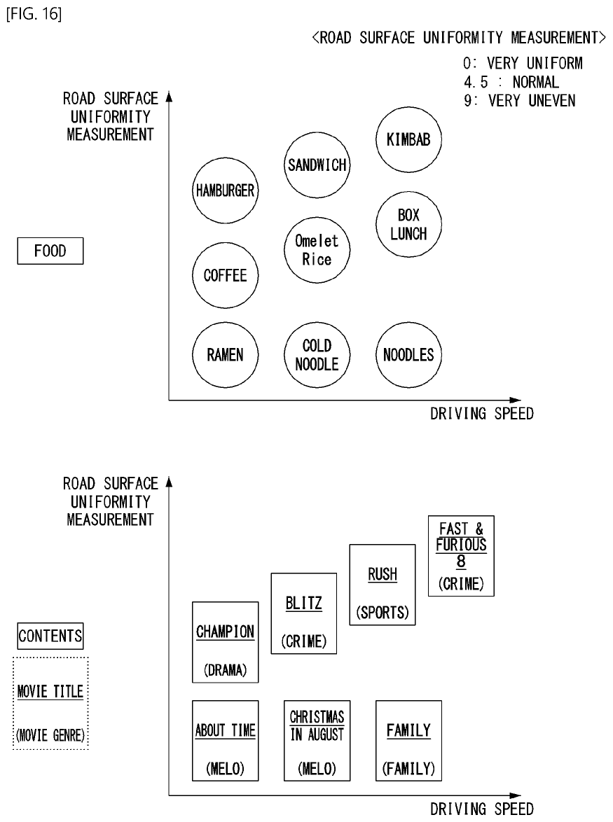

FIG. 16 is an example to which the invention may be applied.

The vehicle 10 may acquire the road surface uniformity measurement of the driving path by FIGS. 8 and 9. The AI processor 261 may provide food suggestion service and contents suggestion service to users according to measurement of road surface uniformity.

For example, the AI processor 261 may provide a user with a list of suggested foods containing broth (e.g., noodles with broth) if the road surface uniformity measurement is close to zero. However, if the road surface uniformity measurement is close to 9, it would be difficult for a user to eat in the vehicle 10 travelling on uneven road surface, so a list of suggested foods including simple-to-eat foods (e.g., gimbap and hamburgers) would be provided.

Further, the AI processor 261 may provide a user with a list of suggested contents that can be classified into melodic, family, and comedy movies when the road surface uniformity measurement is close to zero. However, if the road surface uniformity measurement is close to 9, a list of suggested contents that can be categorized into action, thriller movies may be provided.

In the services, the vehicle's driving speed may be also considered in a similar way.

The suggested food list and suggested contents list may be created through AI technology based on big data, and may also be provided directly from service providers. Therefore, for this, the vehicle (10) may be required to be connected to a server to become a state where the necessary data can be transmitted and received.

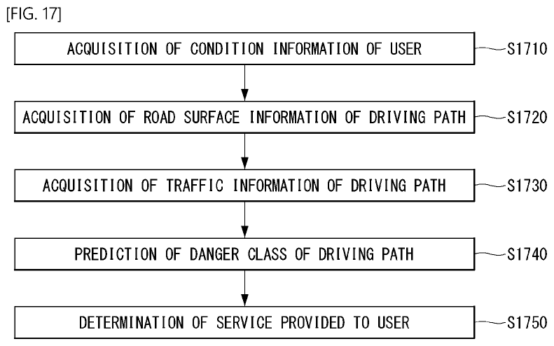

FIG. 17 is an example to which the invention may be applied.

S1710: The processor 170 acquires condition information of a user using a sensor. Through the AI processor 261, the user condition information may be generated as an output with the sensor's sensing data as input values. Alternatively, it may be acquired by the user inputting his or her condition information directly.

S1720: The processor 170 acquires the road surface information of the driving road. This road surface condition information may be updated and managed periodically through the road surface DB.

S1730: The processor 170 acquires the traffic information of the driving road. This traffic information may be periodically acquired and updated.

S1740: The processor 170 predicts the danger class of the driving path. This danger class may be periodically updated.

S1750: The processor 170 may determine the optimal service provided to a user through deep learning, with the acquired user's condition information, the road surface condition information, the traffic information and the danger class as input values, using the AI processor 261 or the AI apparatus 20.

As described above, this invention may provide a user with the driving information described in FIGS. 8 to 15 through the AI technology using FIG. 7, and may provide services using it.

The invention provides a driving path change service, a food suggestion service, a restaurant suggestion service, and contents suggestion service as examples of services provided in FIG. 17, but a similar range of services will also be available.

### Service Type

### 1. Driving Path Change Service

a) Driving path instability

The AI processor (261) analyzes road surface condition information and, if it is determined that the driving path of the vehicle 10 is in an unstable state for safe driving, the processor 170 may automatically change the existing road path to a driving path in a stable state or suggest another one to the user.

In this regard, Example 1 proposed in this invention is as follows.

The driving path in an unstable state may be, for example:

1) In accordance with FIG. 10, a warning message is generated when the degree of non-uniformity of the road surface exceeds the allowable range;

2) In accordance with FIG. 11, a sudden deterioration of the weather (e.g., heavy rain, snow, or the like) causes a message to be issued to warn the road surface is slippery;

3) In accordance with FIG. 15, the danger class of the driving path is determined in the AI processor 261 as a danger class in which safe driving is not possible.

If the driving path is in an unstable state, the processor 170 may automatically change the current driving path to a driving path having a stable state. The driving path in a stable state may mean the shortest-distance driving path in which the aforementioned unstable section is not included.

Example 2 proposed by the invention is as follows.

Automatic change of the driving path may be performed if one of the following four situations is satisfied and it is expected to be possible to arrive within the previous scheduled arrival time even when passing through the changed driving path.

Change proposal of the driving path may be performed if one of the following four situations is satisfied and it is expected to arrive later than the previous scheduled arrival time when passing through the changed driving path.

The aforementioned situations are as follows.

1) The road surface instability state on the existing path is expected to continue;

2) The scheduled arrival time delay due to road surface instability is expected;

3) Because of road surface instability, it is difficult for an occupant to stably consume preordered food;

4) Because of road surface instability, the contents which an occupant has selected beforehand is not appropriate;

Driving path traffic congestion:

In a case where a traffic congestion occurs on the driving path of the vehicle 10, the processor 170 may automatically change the existing driving path to a driving path without traffic congestion, or suggest to a user a driving path without traffic congestion.

In this regard, Example 3 proposed by the invention is as follows.

The state where traffic congestion occurs on the driving path may be a case where traffic congestion is predicted on the basis of, for example, slowing down of vehicles due to bad weather (e.g., heavy rain, snow, or the like), slowing down of vehicles due to a car accident occurring in the surrounding area, slowing down of vehicles due to road construction in the surrounding area, the road traffic condition information by time which may be provided by the AI apparatus 20, or the traffic server.

In the event of a traffic congestion on the driving path, the processor 170 may automatically change to a driving path without traffic congestion. The driving path without traffic congestion may mean the shortest-distance driving path in which the aforementioned traffic congestion is not included.

Example 4 proposed by the invention is as follows.

Automatic change of the driving path may be performed if one of the following three situations is satisfied and it is expected to be possible to arrive within the previous scheduled arrival time even when passing through the changed driving path.

Change proposal of the driving path may be performed if one of the following three situations is satisfied and it is expected to arrive later than the previous scheduled arrival time when passing through the changed driving path.

1) The traffic congestion lasts for predetermined period of time;

2) The scheduled arrival time delay due to the traffic congestion is expected;

3) Because of the traffic congestion, the contents which an occupant has selected beforehand is not appropriate;

These examples may be performed in combination with each of the examples, or may be performed individually. Further, the provision of similar services that may be provided, depending on the service provider, may be included in the invention.

### 2. Food Suggestion Service

a) Food suggestion service depending on driving path:

The vehicle 10 may provide a user with a list of suggested foods which the user can eat comfortably in the road environment. For this, food information including food classified according to the condition information of the driving path may be used. The road environment of the driving path can be defined, for example, as follows.

1) By analyzing road information through high precision maps and navigations, one or more certain sections of the driving path are a straight and flat normal road;

2) By analyzing road information through high precision maps and navigations, one or more certain sections of the driving path include an inclined road or a curved road;

3) The degree of uniformity of the road surface exceeds the allowable range;

In the case as mentioned above, the processor 170 may incorporate the following foods in the list of suggested foods.

1) If one or more certain sections of the driving path are a straight and flat normal road, noodle such as ramen and udong;

2) In a case of an inclined or curved road, and in a case where degree of uniformity of road surface exceeds the allowable range, fast food, snacks while avoiding noodles or menu having broth;

b) Provision of announcement based on driving conditions when a user is eating food:

1) If a user is eating food, when the estimated value of road surface unevenness degree or the estimated value of road inclination degree exceeds a predetermined acceptable range, a notification message regarding this may be provided to the user.

2) When expected danger class of driving path is equal to or higher than a certain class or is abruptly changed, a notification message regarding this may be provided to the user.

c) Food suggestion service depending on arrival time:

The processor 170 may provide the user with a list of suggested foods, taking into consideration the scheduled arrival time, if the user needs a meal. In a case where through traffic condition information provided by the sensing data or the traffic server, an accident is detected in the driving path or the scheduled arrival time is judged to be delayed due to traffic congestion, food that takes a long time to eat may be suggested, as the traffic situation in question needs time to improve. On the contrary, if the traffic situation is good, food that can be eaten fast may be suggested. For this, food information including foods classified according to food intake time may be used.

### 3. Restaurant Suggestion Service

The processor 170 may suggest appropriate restaurants to a user taking road surface information of the driving path into consideration. For example, in the event of uneven road conditions, restaurants selling fast food such as hamburgers may be suggested for easy food intake in the vehicle 10.

For this, the location information of restaurants located on the driving path and the food information sold therein can be acquired through the server, or stored in memory 140 for management.

### 4. Contents Provision/Suggestion Service

a) Contents provision service according to driving path condition:

The AI processor 261 may predict the road surface uniformity, the inclination degree and the slope of the driving path. If such estimated values exceed the allowable range, the processor 170 may stop reproduction of the contents provided to the user, and provide state information on the driving path and sensing image data.

b) Contents suggestion service according to dynamics of the driving path:

If a range greater than a certain range of the driving path is a straight path and has the uniformity of road surface being within the allowable range, the processor 170 may provide the user with contents that include violent screen transitions. However, if the curve path is more than a certain range, or if the road surface uniformity exceeds the allowable range, the processor 170 may suggest alternative driving paths to the user, or suggest other contents. For this, the road information may be used for indicating whether the road constituting the driving path is a straight road.

The disclosure described above may be embodied as a computer-readable code in a medium in which program is recorded. A computer-readable medium includes all kinds of recorders where data that can be read by a computer system is stored. Examples of computer-readable media are hard disk drives (HDDs), solid state disks (SSDs), Silicon disk drives (SDDs), ROMs, RAMs, CD-ROMs, magnetic tape, floppy disks, optical data storage devices, and the like, and include implementation in the form of carrier waves (e.g., transmission over the Internet). Therefore, the detailed description above should not be interpreted in a limited way but should be considered as an example. The scope of the invention shall be determined by a reasonable interpretation of the claims attached, and all changes within the equivalent range of the invention are within the scope of the invention.

Further, in the above examples of service and implementation are described mainly, but these are only examples and do not limit the invention, and a person having an ordinary skill in the art to which the invention belongs are able to know a number of variations and applications not exemplified above are possible without departing from the essential characteristics of the service and implementation example. For example, each component specified in the implementation example can be modified to perform. And, these variants and their application-related differences should be interpreted as being within the scope of the invention as defined in the claims attached.

### INDUSTRIAL APPLICABILITY

While the invention has bee described mainly with regard to an example applied to automated vehicle & highway systems on the basis of 5G (5 generation), it is also possible to apply it to various wireless communication systems and autonomous driving apparatuses besides this.

1. A method of providing a service of a vehicle in automated vehicle and highway systems, the method comprising:
acquiring condition information of a user using a sensor, and determining current behavior information of the user based on the condition information of the user;
acquiring condition information of a driving path;
extracting a characteristic value from the condition information of the driving path;
inputting the characteristic value into a learned deep neural network (DNN) classifier, and
determining a danger class of the driving path from an output of the deep neural network; and
determining a service provided to the user based on the current behavior information of the user, the condition information of the driving path or the danger class,
wherein the service includes a service for changing driving path, a service for food suggestion, a service for restaurant suggestion, or a service for providing or suggesting contents.

2. The method of claim 1, wherein the condition information of the driving path includes traffic information of the driving path, location information of road surface located in the driving path, uniformity information of the road surface, slipperiness information of the road surface, inclination information of the road surface or slope information of the road surface.

3. The method of claim 2, further comprising:
acquiring current location information of the vehicle;
acquiring the uniformity information of the road surface corresponding to the current location information of the vehicle based on the location information of the road surface; and
generating a warning message indicating the road surface is uneven, when uniformity of the road surface exceeds an allowable range, based on the uniformity information of the road surface,
wherein the allowable range is set based on the service.

4. The method of claim 3, further comprising:
acquiring image information of the road surface using the sensor if failing to acquire the uniformity information of the road surface;
extracting a characteristic value relating to whether the road surface is uniform from the image information;
determining the uniformity information of the road surface with the characteristic value relating to whether the road surface is uniform as an input value through the DNN classifier.

5. The method of claim 2, further comprising:
acquiring an appropriate travel distance range corresponding to a number of wheel rotation of the vehicle;
acquiring an actual travel distance corresponding to the number of wheel rotation on the driving path; and
generating a message indicating that the road surface is slippery when the actual travel distance exceeds the appropriate travel distance range, based on the number of same wheel rotation,
wherein the appropriate travel distance range is based on dry asphalt road surface.

6. The method of claim 2, further comprising:
acquiring current location information of the vehicle;
acquiring inclination information of the road surface corresponding to the current location information of the vehicle based on the location information of the road surface; and
generating a warning message indicating the road surface is inclined, when inclination degree of the road surface exceeds an allowable range, based on the inclination information of the road surface,
wherein the inclination information of the road surface is based on variation in rotation angle value of a wheel during a unit period of time, and the allowed range is set based on the service.

7. The method of claim 3, wherein the determining of a service selects the service for changing driving path when the driving path is in an unstable state or in a traffic congestion occurrence state, and
wherein the unstable state is based on the warning message indicating that the road surface is uneven, the warning message indicating that the road surface is inclined, or the danger class, the traffic congestion occurrence state based on the traffic information.

8. The method of claim 2, wherein the service for changing driving path suggests to the user changing the driving path if it is determined that scheduled arrival time at a destination through the driving path is delayed based on the traffic information.

9. The method of claim 2, wherein the determining of a service selects the service for food suggestion, based on the condition information of the driving path, and
wherein the service for food suggestion generates a food list including foods matched with the condition information of the driving path by using food information including foods classified according to the condition information of the driving path.

10. The method of claim 2, wherein the determining of a service selects the service for food suggestion if the current behavior information of the user indicates a behavior of food intake, and
wherein the service for food suggestion generates an announcement message indicating stop of the behavior of food intake, based on the warning message indicating that the road surface is uneven, the warning message indicating that the road surface is inclined, or the danger class, the traffic congestion occurrence state based on the traffic information.

11. The method of claim 2, wherein the determining of a service selects the service for food suggestion, based on the traffic information of the driving path, and
wherein the service for food suggestion is based on food information including foods classified according to food intake time and scheduled arrival time at destination through the driving path.

12. The method of claim 2, wherein the determining of a service selects the service for food suggestion, based on the road surface condition information, the location information of restaurants located on the driving path and the food information sold at the restaurants.

13. The method of claim 3, wherein the determining of a service selects the service for providing or suggesting contents, based on the current behavior information of the user and the condition information of the driving path, and
wherein if the behavior information of the user indicates a behavior of watching contents, the service for providing or suggesting contents stops reproduction of the contents, and provides the condition information of the driving path or sensing data of the driving path, based on the warning message indicating that the road surface is uneven, or the warning message indicating that the road surface is inclined.

14. The method of claim 2, wherein the service for providing or suggesting contents displays selected contents, or generates a suggestion contents list, based on the condition information of the driving path, and
wherein the condition information of the driving path includes road information indicating whether a road constituting the driving path is straight.

15. The method of claim 2, wherein the acquiring of traffic information of the driving path receives through V2X message using V2X communication through PC5 interface from other autonomous vehicles, or is received from a server.

16. The method of claim 2, wherein the condition information of the driving path includes danger facility information located on the driving path, and
wherein the danger facility information receives through V2X message using the sensor or using V2X communication through PC5 interface from other autonomous vehicles, or is received from a server.

17. A vehicle which provides a service in automated vehicle and highway systems, the vehicle comprising:
a sensing unit formed with a plurality of sensors;
a communication unit;
a memory; and
an artificial intelligence (AI) processor,
wherein the AI processor acquires condition information of a user using the sensing unit, determines the current behavior information of a user based on the condition information of a user; acquires condition information of a driving path; extracts a characteristic value from the condition information of the driving path; inputs the characteristic value into a learned deep neural network (DNN) classifier, determines a danger class of the driving path from an output of the deep neural network, determines a service provided to the user based on the current behavior information of the user, the condition information of the driving path or the danger class, wherein the service includes a service for changing driving path, a service for food suggestion, a service for restaurant suggestion, or a service for providing or suggesting contents.
